(19) United States
(12) Patent Application Publication
(10) Pub. No.: US 2007/0022416 A1
(43) Pub. Date: Jan. 25, 2007

(54) Execution device and application program

(76) Inventor: Yukio Masuda, Osaka (JP)

Correspondence Address: MCDERMOTT WILL & EMERY LLP, 600 13TH STREET, N.W., WASHINGTON, DC, 20005-3096, US

(21) Appl. No.: 11/485,625

(22) Filed: Jul. 13, 2006

(30) Foreign Application Priority Data
Jul. 15, 2005 (JP) 2005-207412

(51) Int. Cl. G06F 9/45

(52) U.S. Cl. 717/151

(57) ABSTRACT

An execution device includes one or more memories for use when executing an application program. The execution device selects one of a plurality of patterns relating to memory areas required for executing the application program, secures memory areas in the one or more memories in accordance with the selected pattern, and executes using the secured memory areas.

### BACKGROUND OF THE INVENTION

(1) Field of the Invention

The present invention relates to an application program execution device, and especially to a technology for using memory effectively.

(2) Description of the Related Art

In recent years, an increasing number of household appliances and audio/video apparatus are equipped with a computer system.

Regarding the computer systems of such mass-produced appliances and apparatus, it is generally the case that the processing power of the processor and amount of memory are limited due cost requirements. In such computer systems, the hardware and OS (Operation System) are usually optimized to include only those functions used by the application program.

One method for optimizing the allocation of memory resources is described in Patent Document 1. The disclosed technology finds optimum memory allocation in advance by running a simulation of the program on a model of the system.

To secure the amount of memory necessary for execution, the application program requests to the OS an allocation of the required amount of memory.

For instance, a type of DSP (Digital Signal Processor) is provided with a group of software modulus called a framework 10 for simplifying the development of applications, as shown in FIG. 9. When requiring memory resources 14, software modules 11, 12, and 13 secure memory via an API (Application Program Interface) of the framework 10 (see Non-Patent Document 1).

As described above, such a system having limitations on hardware resources and OS usage aims to improve processing performance without sacrificing cost down, through efficient use of a limited amount of memory and simplification of the development of the application program.

Non-Patent Document 1:

Texas Instruments Incorporated, “TMS320 DSP Algorithm Standard—Rules and Guidelines”, October 2002

Patent Document 1:

Japanese Patent Application Publication No 2004-70862

### SUMMARY OF THE INVENTION

However, as a result of being developed for the system of a specific apparatus, it is often the case that application programs of the type described above are not capable of achieving an acceptable level of performance on other apparatus.

Thus, in an unaltered form, the application program may not be executable due to a lack of memory resources. Even when executable, the application program may not achieve an acceptable level of processing performance when the amount of available memory is small. Another possibility is that the required level of processing performance can be achieved, but the application program cannot use the memory resources of the apparatus effectively, and is unable to achieve a level of performance commensurate with the amount of available memory.

Thus, in order to achieve a level of performance appropriate to each of a number of apparatuses, it may be necessary to provide a different program for each apparatus even if the object of each application program is the same.

However, due to development costs and user convenience, it is preferable that a single application program is executable on a number of different apparatuses to achieve an acceptable level of performance.

Also, in some instances, an apparatus may not able to execute the application program due to a lack of memory caused by the operation of other programs. It is therefore preferable that the application program is executable in a way that is suitable to a current state of the execution device.

In view of the above problems, the present invention aims to provide an application program and an execution device capable of achieving a satisfactory level of performance, regardless of different hardware structures and different environments.

In order to achieve the above aim, one aspect of the present invention provides an execution device having at least one memory used by an application program during execution, including: a storage unit operable to store a plurality of memory allocation patterns each relating to one or more memory areas of the at least one memory used for executing the application program; a selection unit operable to select one of the memory allocation patterns stored in the storage unit; an allocation unit operable to allocate the one or more memory areas in accordance with the memory allocation pattern selected by the selection unit; and an execution unit operable to execute the application program using the one or more memory areas allocated by the allocation unit.

With the above construction, the execution device of the present invention is able allocate the memory required by the application program from the available memory, iii a way that takes into account how much memory is available. The application program can therefore be executed in a way that takes into account the current state of the execution device.

The application program may be provided with a plurality of memory allocation patterns to enable the execution device to achieve a sufficient level of performance when the program is executed. In this case, the execution device selects the memory allocation pattern corresponding to the amount of available memory. The application program is then able to operate at a maximum level of performance for the amount of available memory, while the execution device is able to make efficient use of the memory resources.

Here, the application program may include a procedure corresponding to each memory allocation pattern stored in the storage unit, and the execution unit may be operable to execute at least the procedure corresponding to the selected memory allocation pattern using the one or more memory areas allocated by the allocation unit.

With this construction, the application program is able to perform processing in accordance with the memory allocation pattern, and is therefore able to achieve a maximum level of performance. For example, in the case that various types of memory are available, the program is able to increase the processing speed by allocating the different types of memory depending on the type and amount of data.

Here, the execution device of the present invention may further include an acquisition unit operable to acquire information relating to free areas of the one or more memories, wherein the selection unit selects the one of the memory allocation patterns based on the acquired information.

With this construction, memory resources are allocated from the available memory. Consequently it is possible to avoid not being able to execute the application program due to insufficient memory.

Here, the memories may be of different types corresponding to different access speeds, and each memory allocation pattern may indicate a required amount of memory of each type.

With this construction, the minimum amount of memory of each type is secured. Consequently, the processing of the application program can be performed efficiently, and a high level of performance achieved.

Here, the execution device of the present invention may further include: an access frequency storage unit operable to store an access frequency estimated for each of one or more data objects to be used during execution of the application program; and a placement unit operable, when the execution unit executes the application program, to place the one or more data objects in the memory areas allocated by the allocation unit, wherein the placement unit places the one or more data objects according to the access frequencies stored in the access frequency storage unit.

With this construction, data objects are placed in areas of the memories in accordance with usage frequency. This enables the average time taken for the application program to access a data object to be reduced.

Here, the execution device of the present invention may further include: a priority level storage unit operable to store a priority level for each of one or more data objects to be used when the application program is executed; and a placement unit operable, when the execution unit executes the application program, to place the one or more data objects in the memory areas allocated by the allocation unit, wherein the placement unit places, in order of decreasing priority, the one or more data objects using the priority levels stored in the priority level storage unit, and when the application program is executed, the execution unit suppresses execution of portions of the application program that use data objects not placed by the placement unit.

With this construction, data having a high usage frequency can be placed in fast memory. This enables the processing speed of the application program to be increased.

Another aspect of the present invention provides an application program for causing an execution environment to execute functions for allocating and releasing memory, including steps of: transmitting to the execution environment a plurality of differing memory allocation patterns relating to memory areas to be used when the application program is executed; and acquiring from the execution environment one of the memory allocation patterns transmitted in the transmission step, wherein prescribed processing to be performed by the execution environment is defined using the memory areas allocated in accordance with the acquired memory allocation pattern.

With this construction, the application program of the present invention operates using memory resources allocated according to the state of the execution environment. Further, the application program is able achieve a high level of performance without wasting memory. Consequently, the application program is executable in various execution environments and achieves an acceptable level of performance.

Here, the application program may use one or more data objects during execution, one or more sets of prescribed processing being in one-to-one correspondence with the one or more data objects, and further including steps of: judging whether one of the one or more data objects has been placed in the allocated memory area; and controlling, in the execution environment, execution of the set of prescribed processing that corresponds to the data object judged to have been placed in the judging stop.

With this construction, the application program is executed so as to carry out the processing selected in accordance with the amount of memory resources secured in the execution environment. The application program is therefore executable in various execution environments.

Yet another aspect of the present invention provides an execution device having at least one memory used by an application program during execution, comprising: a storage unit operable to store a plurality of memory allocation patterns each relating to one or more memory areas of the at least one memory used for executing the application program; a selection unit operable to select one of the memory allocation patterns stored in the storage unit; a notification unit operable to notify the application program of information relating to the memory allocation pattern selected by the selection unit.

With this construction, the execution device of the present invention can provide the memory resources requested by the application program based on how much memory is in use. The execution device can therefore execute the application device in a way that takes its own situation into account.

### BRIEF DESCRIPTION OF THE DRAWINGS

These and other objects, advantages and features of the invention will become apparent from the following description thereof taking in conjunction with the accompanying drawings which illustrate a specific embodiment of the invention. In the Drawings:

FIG. 1 is a functional block diagram showing the construction of the execution device of a first embodiment of the present invention;

FIG. 2 shows an example of memory allocation pattern information 1310;

FIG. 3 shows an example of information relating to allocated memory resources;

FIG. 4 is a flow-chart indicating processing performed by the application program for memory allocation;

FIG. 5 is a graph showing cache hit rates;

FIG. 6 is a block diagram showing the construction of the execution device of a second embodiment of the present invention;

FIG. 7A shows an example of memory allocation information 2310, and FIG. 7B shows an example of essential memory information;

FIG. 8A shows an example of data priority information 2410, and FIG. 8B shows an example of how data objects are placed in the memory; and

FIG. 9 shows an example of prior art in which memory allocation is obtained via the framework.

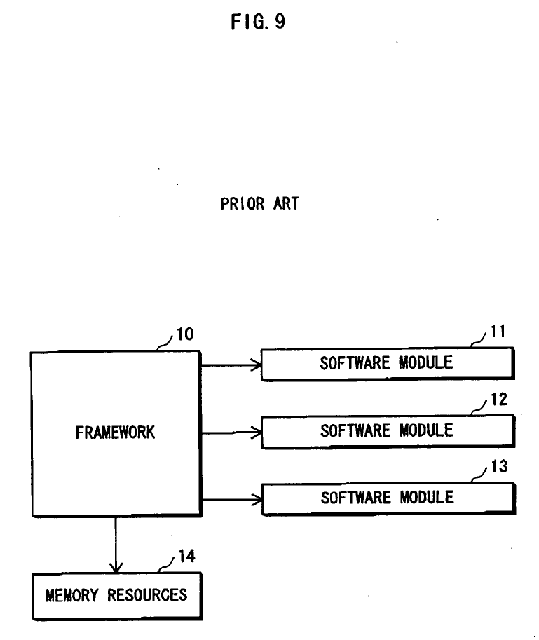

### DESCRIPTION OF THE PREFERRED EMBODIMENT

Overview

The present invention is to dynamically find a balance between the memory resources requested by an application program (hereinafter “program”) and the memory resources available in an execution device at the time of the request.

According one feature of the present invention, the program running on the execution device is provided in advance with a plurality of memory allocation patterns and includes a plurality of sets of processing steps each associated with a different one of the plurality of patterns. For example, the program includes, for each of the patterns, a different set of processing steps performed for data placement and for achieving the object of the program.

Each memory allocation pattern provided for use by the program is determined in advance and indicates a combination of memory amounts to be secured in memories of differing performance levels in order for the program to achieve a predetermined level of performance.

When the program makes a request for memory, the execution device selects an appropriate one of the memory allocation patterns based on the execution state of other programs and the memory resources provided in the execution device, and allocates memory accordingly.

After memory allocation, the program selectively executes processing corresponding to the selected pattern. As a result, the program can perform processing which maximizes use of the memory resources allocated in the device, and achieve a high level of performance.

Moreover, the execution device can allocate memory resources without waste, and thus without interfering with other programs running on the execution device.

The following describes the program and execution device of the present invention.

In a first embodiment of the present invention, while the overall amount of memory to be allocated does not change, the ratio of amounts of memory of differing performance differs between patterns. In a second embodiment of the present invention, the total amount of memory varies between patterns.

### FIRST EMBODIMENT

Construction

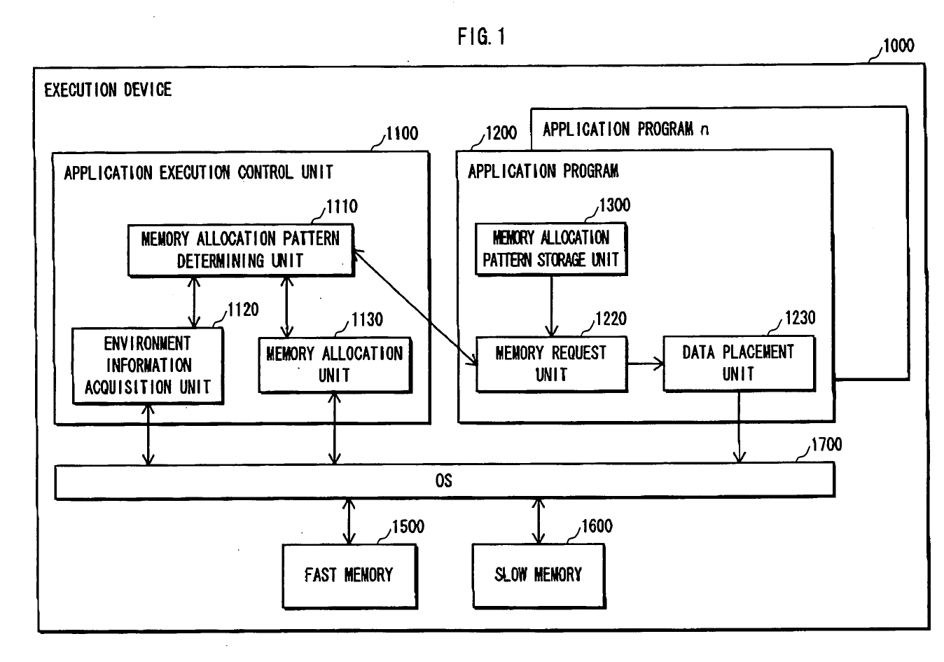

The following describes the execution device of the first embodiment of the present invention with reference to FIG. 1.

In the description, it is assumed that the program of the present invention is already loaded in the execution device.

FIG. 1 is a functional block diagram showing the construction of the execution device.

The execution device 1000 is constructed from an application execution control unit 1100, an application program 1200, a fast memory 1500, a slow memory, and an OS 1700.

The OS 1700 is basic software that manages the various resources of the execution device, and manages execution of the program. For example, the OS performs processing to allocate and free memory for the application program.

The fast memory 1500 and the slow memory 1600 are memories with different access speeds. These memories are included in the functional block diagram of FIG. 1 to show the interaction between the memories and the OS 1700.

Here, the fast memory 1500, which can be accessed faster, may be SRAM (Static RAM) and the slow memory 1600 may be DRAM (Dynamic RAM).

The application program 1200 is software for performing a specific task, such as movie playback, word processing, or the like. The application program 1200 secures memory of the required size from the memories (1500 and 1600) in the execution device 1000 via the OS 1700, and executes the processing using the allocated memory.

Here, it is assumed that a plurality of application programs can be loaded in the execution device 1000, and that these programs may be executed in parallel. For simplicity, a single application program 1200 is described here.

Besides performing execution and control processing relating to the specific task, the application program 1200 performs processing specific to the present invention.

The application program 1200 is constructed from a memory allocation pattern storage unit 1300, a memory requesting unit 1220, and a data placement unit 1230.

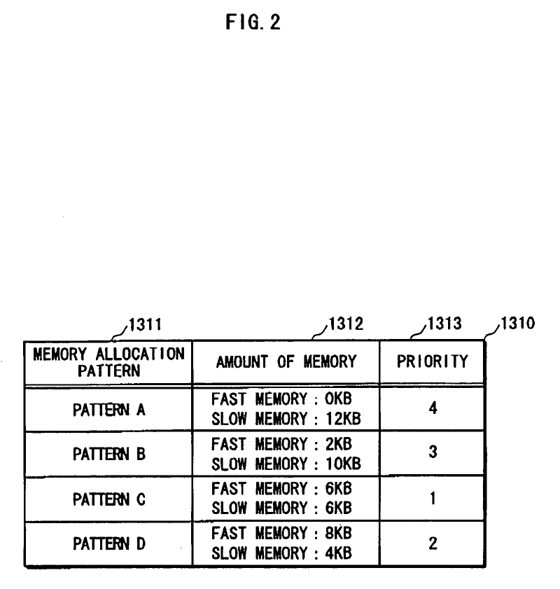

The memory allocation pattern storage unit 1300 functions to store a plurality of memory allocation patterns which enable the application program to run efficiently. The details of the stored memory allocation pattern will be described later with reference to FIG. 2.

The application program 1200 is able to achieve a predetermined level of performance using any of the stored plurality of memory allocation patterns. Furthermore, the amounts of memory described in each pattern are so determined that minimum memory is wasted.

The memory requesting unit 1220 functions to secure the memory resources required by the application program 1200. Specifically, the memory requesting unit 1220 makes requests for memory resources to the application execution control unit 1100, which is described in later section, and receives a start address of the allocated memory. The memory is allocated in accordance with one of the allocation patterns stored in the memory allocation pattern storage unit 1300.

The data placement unit 1230 functions to place the data objects that are to be used by the application program 1200 in the memory secured by the memory request unit 1220.

The data placement unit 1230 places data objects to memory areas allocated in accordance with the selected memory allocation pattern.

The data objects managed by the data placement unit 1230 refer to a chunk of data, each of which is placed in a contiguous memory area (this applies to all data in the description). Further, the data may refer to the program, the work area, or the like.

In addition to the control processing generally required to execute the program, the application execution control unit 1100 performs the control processing that is specific to the present invention.

The application execution control unit 1100 is constructed from a memory allocation pattern determining unit 1110, an environment information acquisition unit 1120, and a memory allocation unit 1130.

The memory allocation pattern determining unit 1110 functions to secure memory resources in response to a memory request from the application program 1200, and to return the start address of the allocated memory and the memory allocation pattern used to allocate the memory.

The memory allocation pattern determining unit 1110 calculates the amount of memory that can be allocated to the application program 1200 based on current use of the memory resources and expected further use by the execution device 1000, and selects the memory allocation pattern on the basis of the calculated amount.

The environment information acquisition unit 1120 functions to acquire, from the OS 1700 and other sources, information relating to the execution environment of the application program. This information includes the amount of available memory in the memories (1500 and 1600) of the execution device 1000.

The memory allocation unit 1130 functions to secure a predetermined amount of the slow memory 1500 or the fast memory by making a request to the OS 1700.

Here, a part or all of the various processing performed by the application execution control unit 1100 and other units is realized by a CPU (Central Processing Unit, not depicted) executing programs of various types.

Data

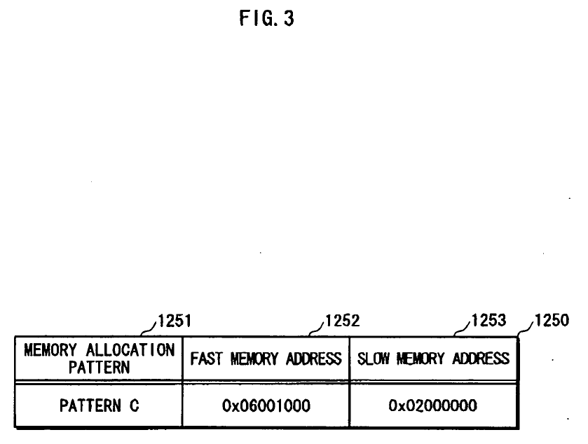

The following describes the main data used by execution device 1000 with reference to FIGS. 2 and 3.

FIG. 2 shows an example of memory allocation pattern information 1310.

The memory allocation pattern information 1310 is stored in the memory allocation pattern storage unit 1300. There may be more than one piece of allocation pattern information. Each memory secured by the application program 1200 may have a corresponding piece of allocation pattern information.

The memory allocation pattern information 1310 is passed to the application execution control unit 1100 when the application program 1200 makes a memory allocation request thereto.

The memory allocation pattern information 1310 indicates a plurality of memory allocation patterns each specifying amounts of fast memory 1500 and slow memory 1600. These amounts are determined in advance using simulation or the like, and enable the application program to achieve a prescribed level of performance without wasting memory resources. In this embodiment, the overall amount of memory is the same in each memory allocation pattern but the proportions of fast and slow memory differ between the memory allocation patterns.

The allocation pattern information 1310 includes, for the respective patterns, a memory allocation pattern 1311, an amount of memory 1312, and a priority 1313.

The memory allocation pattern 1311 indicates a pattern name uniquely identifying a respective pattern.

The amount of memory 1312 indicates amounts of the fast memory 1500 and the slow memory 1600. For instance, for the memory allocation pattern 1311 “pattern C”, the amount of memory 1312 indicates “fast memory: 6 KB, slow memory: 6 KB”. In other words, according to the “pattern C”, 6 KB (kilobyte) of fast memory 1500 and 6 KB of slow memory 1600 are to be allocated.

The priority 1313 indicates the priority that is ranked in the decreasing order of the performance levels expected to be achieved through the use of respective memory allocation patterns. For instance, as indicated in the columns of the memory allocation pattern 1311 and the priority 1313, the “pattern C” has the priority “1”. This means that “pattern C” is the most highly recommended of the “patterns A to D”.

Typically, a higher the proportion of fast memory gives a higher level of processing performance. However, in the example “pattern C”, which has the second largest amount of fast memory, has a priority 1313 of “1”. This is because the processing performance of the application program does not change much when more than 6 KB of fast memory is used. Therefore, the “pattern C” having 6 KB of fast memory is able to use the memory resources most efficiently.

FIG. 3 shows an example of memory resource information 1250 relating to allocated memory resources.

This memory resource information 1250 is passed to the application program 1200 from the application execution control unit 1100.

This information is created by the memory allocation pattern determining unit 1110 every time memory resources are secured, and passed to the memory request unit 1220.

The memory resource information 1250 includes a memory allocation pattern 1251, a fast memory address 1252, and a slow memory address 1253.

The memory allocation pattern 1251 indicates the selected one of the memory allocation patterns 1311 included the memory resource pattern information 1310. For instance, the memory allocation pattern 1251 may be “pattern C”. From this information it is clear how much of each type of memory is allocated.

The fast memory address 1252 and the slow memory address 1253 are start addresses for each of the allocated memories. For instance, when the memory allocation pattern is “pattern C”, the fast memory address 1252 indicates that the start address of the 6 KB area secured in the of fast memory starting is “0x06001000”.

Operation

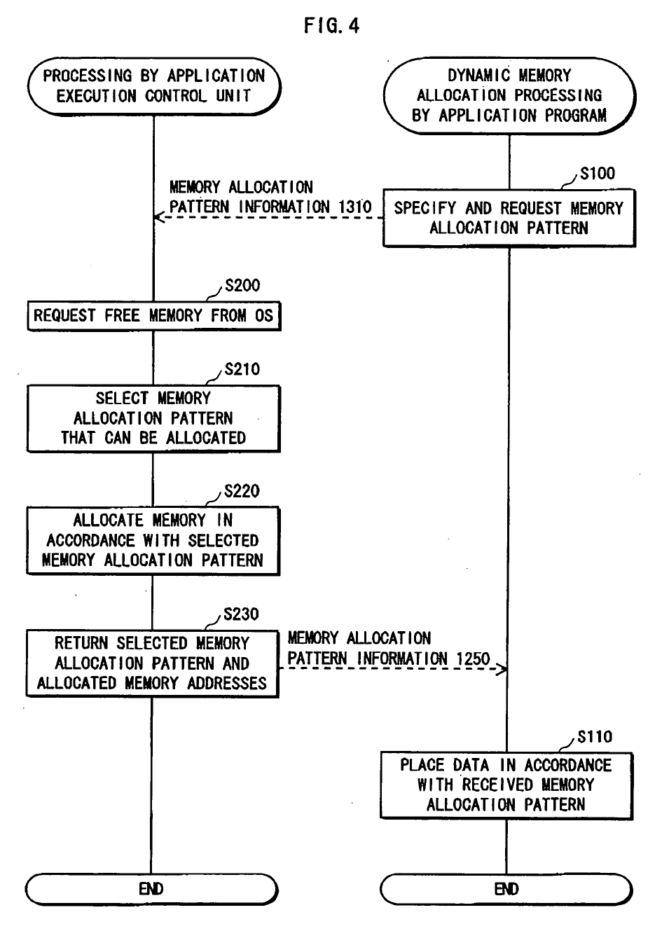

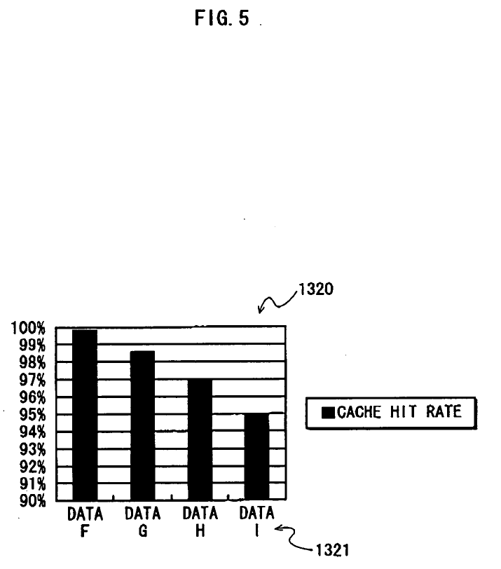

The following describes the operation of The execution device 1000 with reference to FIG. 4 and FIG. 5.

FIG. 4 is a flowchart indicating the processing for the application program to secure memory.

The application program 1200 makes a memory allocation request to the memory request unit 1220 as necessary during initialization processing immediately after starting execution, or during execution.

On receipt of the memory allocation request, the memory request unit 1220 reads the memory allocation pattern information 1310, which is associated with the application program 1200, from the memory allocation pattern storage unit 1300. The memory request unit 1220 then passes the memory allocation pattern information 1310 to the memory allocation pattern determining unit 1110 of the application execution control unit 1100, thereby requesting to secure memory resources (Step S100).

On receipt of the request for securing memory resource, the memory allocation pattern determining unit 1110 requests the environment information acquisition unit 1120 for information about available areas in the fast memory 1500 and the slow memory 1600.

The environment information acquisition unit 1120 then checks with the OS 1700 and returns information about available areas in each of the memories to the memory allocation pattern determining unit 1110 (Step S200).

On receipt of the information about the available areas, the memory allocation pattern determining unit 1110 selects an applicable one of the memory allocation patterns 1311 with the highest priority 1313 (Step S210).

For instance, if 10 KB of fast memory and 6 KB of slow memory are available, “pattern C” will be selected. In this case, both “pattern C” and “pattern D” are applicable. Since “pattern C” and “pattern D” have the priorities 1313 “1” and “2”, respectively, “pattern C” having a higher priority is selected.

Having selected the memory allocation pattern 1311, the memory allocation pattern determining unit 1110 passes the selected memory allocation pattern to the memory allocation unit 1130, and makes a request for memory allocation.

On receipt of the request for memory allocation, the memory allocation unit 1130 makes a request to the OS 1700 for a memory allocation including the fast memory 1500 and the slow memory 1600. In the case that “pattern C” has been selected, the request is for 6 KB of the fast memory 1500 and 6 KB of the slow memory 1600.

The OS 1700 secures the requested amount of the fast memory 1500 and the slow memory 1600 and returns the start addresses of the allocated memory to the memory allocation unit 1130 (Step S220).

On receipt of the start addresses, the memory allocation unit 1130 creates memory resource information 1250 from the received start addresses and the selected memory allocation pattern, and returns the memory resource information 1250 to the memory request unit 1220 (Step S230). More specifically, for example, the memory allocation unit 1130 creates the memory resource information 1250 that includes: the memory allocation pattern 1251 indicating “pattern C”; the fast memory address 1252 indicating the start address of a 6 KB memory area secured in the fast memory; and the slow memory address 1253 indicating the start address of a 6 KB memory area secured in the slow memory.

On receipt of the memory resource information 1250, the memory request unit 1220 passes the received information to the data placement unit 1230, thereby requesting the data placement unit 1230 to load data objects according to the received information.

On receipt of the load request, the data placement unit 1230 places data objects in the respective memories (Step S110), and subsequently continues with the process of the application program.

Here, data objects may be placed in a predetermined placement order. In this embodiment, however, the data placement unit 1230 determines whether to place each data object in the fast memory on the slow memory based on a data usage frequency of the data object.

The following describes examples of the data placement method.

In this embodiment, the data usage frequency is assessed using the cache hit rate for the data. This method of assessment is described with reference to FIG. 5.

FIG. 5 is a graph showing examples of the cache hit rate of the data area.

The graph 1320 shows cache hit rates for each of the data objects F to I (1321) in the case that all data used by the application program is placed in the slow memory 1600 and the cache memory is used to access the slow memory 1600.

The cache hit rate is a ratio at which, when accessing a data object, the application program 1200 finds the data object in the cache memory rather than in the slow memory 1600, within a prescribed period or a prescribed number of accesses.

In this example, the cache hit rate for the data object F is 99.8% while the cache hit rate for the data object I is 95%.

The data placement unit 1230 stores in advance the cache hit rate information, and places the respective data objects in the fast memory in the increasing order of cache hit rate. Thus, the data objects I, H, G, and F are placed in the stated order. When there are any data objects that cannot be placed in the fast memory, such data objects are then placed in the slow memory.

By placing the data objects in this way, the speed of access to data having a low cache hit ratio increases, and the overall processing speed of the application program increases accordingly.

Since is generally the case the speed of access to slow memory is increased using cache memory, improving the cache hit rates enables an increase in the processing speed of the program.

Note that the cache hit rate information stored in the data placement unit 1230 is estimated in advance. The cache hit rate information may, however, be updated at regular intervals during execution of the program and used to relocate data objects at appropriate timing.

### SECOND EMBODIMENT

Differences from First Embodiment

The following describes the second embodiment of the present invention. According to the first embodiment described above, all the allocation patterns require the same amount memory. According to the second embodiment, however, each memory allocation pattern requires a different amount memory.

Since the overall amount of required memory is variable, an advantageous effect is archived that a wider variety of devices is able to run the application program.

According to the second embodiment, a mechanism to select data objects to be placed in memory is added to more suitably manage the case where the amount of allocated memory is small.

Operation

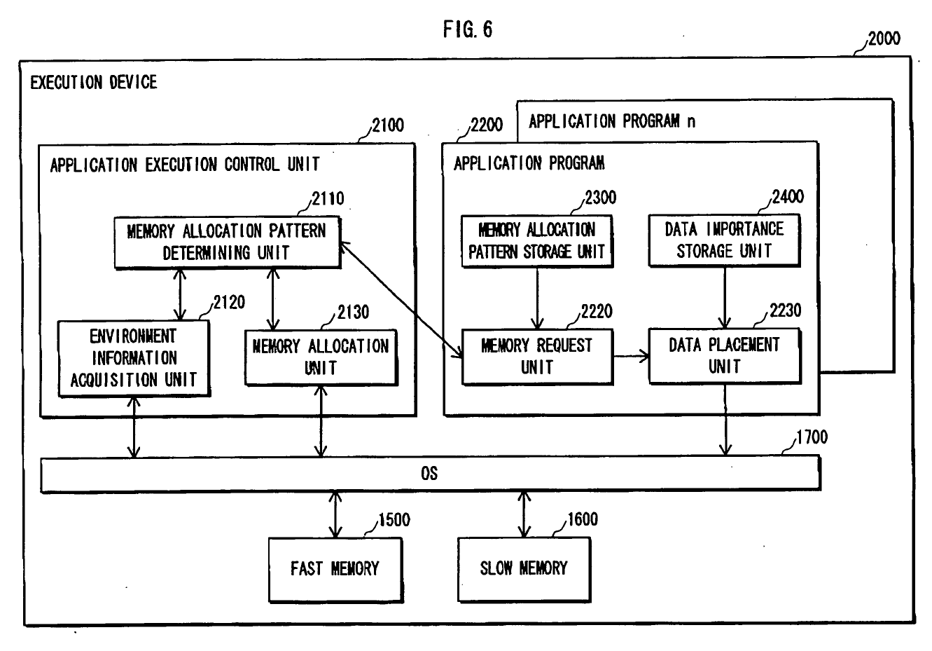

The following describes the execution device of the second embodiment of the present invention using FIG. 6.

FIG. 6 is a functional block diagram showing the construction of an execution device of the second embodiment.

This execution device differs from the one of the first embodiment in that an application program 2200 includes a data priority level storage unit 2400.

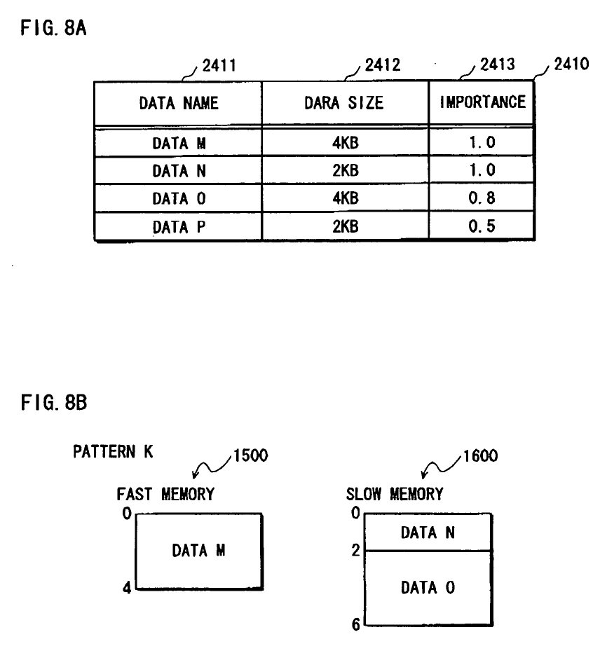

The data priority level storage unit 2400 stores information including priority levels for data used by the application program. The details of the priority level information will be given later with reference to FIG. 8. A data placement unit 2230 places the data according to the priority levels.

Although differing on this point, the functional units of the execution device 2000 are largely the same as those of the execution device 1000 (See FIG. 1).

Each of the functional units is briefly described below.

The execution device 2000 is constructed from an application execution control unit 2100, the application program 2200, the fast memory 1500, the slow memory 1600, and the OS 1700.

The OS 1700, the fast memory 1500 and the slow memory 1600 are identical to those in the execution device 1000.

The application program 2200, is constructed from a memory allocation pattern storage unit 2300, a memory request unit 2220, a data placement unit 2230, and the data priority level storage unit 2400.

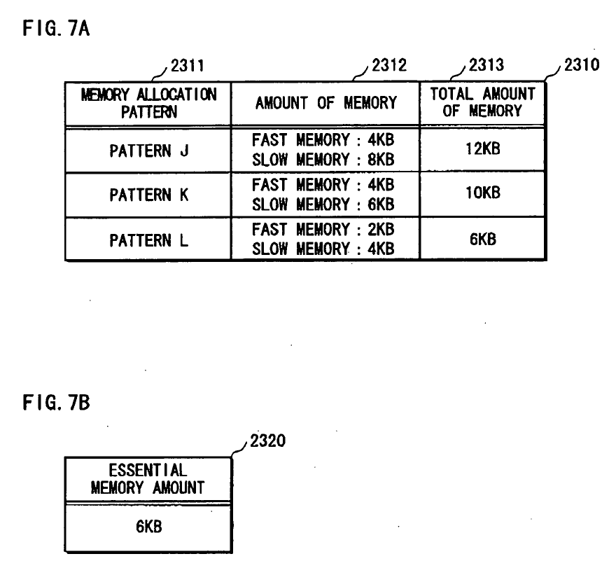

The memory allocation pattern storage unit 2300 stores an essential memory amount and a memory allocation pattern, which are described in a later section with reference to FIG. 7.

The memory request unit 2220 functions identically to the memory request unit 1220 of the execution device 1000, except in that the memory request unit 2220 makes a request for memory based on one of the memory allocation patterns stored in the memory allocation pattern storage unit 2300.

The data placement unit 2230 functions to place data and the like in memory secured by the memory request unit 2200 with reference to information stored in the data priority level storage unit 2400.

The application execution control unit 2100 is constructed from a memory allocation pattern determining unit 2110, an environment information acquisition unit 2120 and a memory allocation unit 2130.

The difference between functions of the memory allocation pattern determining unit 2110 and those of the memory allocation pattern determining unit 1110 of the execution device 1000 is that the memory allocation pattern determining unit 2110 checks how much memory is necessary. If this amount of memory cannot be allocated, the memory allocation pattern determining unit 2110 will not allocate memory.

The environment information acquiring unit 2120 and the memory allocation unit 2130 are identical in functionality to the environment information acquiring unit 1120 and the memory allocation unit 1130 of the execution device 1000, respectively.

Data

The main data used by the execution device 2000 is described in FIGS. 7 and 8.

FIG. 7A shows an example of the memory allocation pattern information 2310.

The memory allocation pattern information 2310 is stored in the memory allocation pattern storage unit 2300, and differs from the memory allocation pattern information 1310 of the first embodiment in having a total amount of memory 2313 rather than the priority 1313.

The memory allocation pattern information 2310 is passed to the application execution control unit 2100 when the application program 2200 makes a memory allocation request thereto.

As in the first embodiment, each of the memory allocation patterns included in the memory allocation pattern information 2310 indicates amounts of the fast memory 1500 and the slow memory 1600. These amounts are determined in advance using a simulator or the like.

The memory allocation pattern information 2310 is constructed from a memory allocation pattern 2311, an amount of memory 2312, and a total amount of memory 2313.

The memory allocation pattern 2311 and the amount of memory 2312 are the same as the memory allocation pattern 1311 and the memory amount 1312 according to the first embodiment.

The total amount of memory 2313 is the sum of the required amounts of fast and slow memory.

FIG. 7B slows an example of a piece of essential memory information.

The essential memory information 2320 indicates the minimum amount of memory required for the application program 2200 to operate.

The essential memory information 2320 is stored in the memory allocation pattern storage unit 2300, and is passed to the memory allocation pattern determining unit 2110 via the memory request unit 2220.

FIG. 8A shows data importance information 2410 and is stored in the data importance information unit 2400.

The data importance information 2410 is constructed from a data name 2411, a data size 2412, and an importance 2413.

The data name 2411 indicates the names of data objects used by the application program 2200, and acts as in identifier.

The data size 2412 expresses a data length of the data object indicated by the data name 2411. For instance, a data object with the data name 2411 “data object M” corresponds to a data size 2412 of “4 KB”. That means, the “data object M” is four-kilobyte data.

The importance 2413 is a value indicating the level of importance of the data object indicated by the data name 2411, a greater value indicating a higher degree of importance. The data objects are sequentially placed first in the fast memory and then in the slow memory in accordance with this order of importance. Alternatively, the position at which a respective data object may be placed in the memory may also be determined according to the degree of importance of the data object.

The importance is assigned a numerical value according to the importance of the corresponding data object to the application program.

Specifically, a value of “1” indicates that the corresponding data object is essential to operation of the application program. Consequently, the amount of required memory indicated by essential memory information 2320 is determined by calculating the total amount of data objects having the value “1” as the importance 2413.

For instance, the data objects identified by the data names 2411 “data M” and “data N” both have an importance 2413 of “1”, and differing data sizes of 4 KB and 2 KB, respectively. Consequently the essential amount of memory 2320 will be “6 KB”.

FIG. 8B shows an example of how the data object are placed in the memory.

In this example the memory allocation pattern 2311 is “pattern K” (See FIG. 7A). The “data object M” is placed in the 4 KB of the fast memory 1500, while the “data object N” and the “data object O” are placed in the 6 KB of slow memory. In this example, “data object P” is not placed.

The relationship between the importance 2413 of each data object and the application program 2200 is described below.

The data objects having an importance 2413 of “1” are required by the application program for essential processing, and have to be placed in memory.

If a data object has an importance 2431 of less than 1, on the other hand, not placing the data object has no effect on the essential processing.

Typical examples of such a data object include data for additional processing not required for executing the algorithms, or data used only for specific modes of operation that are not normally required. The application program is written so that, if such a data object has not been placed in memory, the corresponding processing is not performed.

For instance, the application program may be used to playback a music video. In this case, the processing to decrypt the encrypted content, and the processing to play back the music is essential processing, so the importance of the data objects (say “data object M” and “data object N”) required for this processing will be “1”. However, the processing to play back the video content is not essential, so the importance of data (“data object O”) used in this processing is “0.8”. Furthermore, the data (“data object P”) used in processing to display text data for the lyrics or the like has a low importance of “0.5”.

Operation

The following describes the operation of the execution device 2000 with reference to FIG. 4.

FIG. 4 is a flowchart indicating the processing performed by the application program to obtain an allocation of memory. FIG. 4 is also referred to in the description of the first embodiment.

The processing of Step S100, Step S110 and Steps S200 to S230 is substantially the same as that performed by the first execution device 1000.

The processing differs from the processing by first execution device on three points.

Firstly, the memory allocation pattern 2310 (see FIG. 7) is used in place of the memory allocation pattern 1310 (see FIG. 2). Secondly, the memory allocation pattern determining unit 2110 checks the amount of essential memory 2320. Thirdly, the data placement unit 2230 places the data on the basis of the data importance information 2410.

The following briefly describes the operation of the execution device 2000.

The application program 2200 issues a memory allocation request to the memory request unit 2220.

On receipt of the memory allocation request, the memory request unit 2220 reads the memory allocation pattern information 2310, which is associated with the application program 2200, from the memory allocation pattern storage unit 2300. The memory request unit 2220 then passes the memory allocation pattern information 2310 to the memory allocation pattern determining unit 2110 of the application execution control unit 2100, thereby requesting to secure memory resource (Step S100).

On receipt of The request for securing memory resources, the memory allocation pattern determining unit 2110 then requests information about available areas in the memory from the environment information acquisition unit 2120 (Step S200)

On receipt of the information about the available areas, the memory allocation pattern determining unit 2110 judges whether the amount of essential memory 2320 can be secured, and if judging in the affirmative, selects one of the memory allocation patterns 2311. If an allocation matching one of the memory allocation patterns 2311 cannot be secured, the memory allocation pattern determining unit 2110 attempts to secure the amount of essential memory in the fast and/or slow memory (Step S210).

Having selected the memory allocation pattern 2311, the memory allocation pattern determining unit 2110 secures the memory via the memory allocation unit 2130 (Step S220), and receives the start address (Step S220).

On receipt of the start addresses, the memory allocation unit 2130 creates memory resource information 2250 from the received start addresses and the selected memory allocation pattern, and returns the memory resource information 2250 to the memory request unit 2220 (Step S230).

On receipt of the memory resource information 2250, the memory request unit 2220 passes the received information to the data placement unit 2230, and requests that data is loaded. On receipt of the load request, the data placement unit 2230 places data in the respective memories (Step S110), and subsequently continues with the process of the application program 2200.

The following describes examples of the data placement method.

In the first embodiment the data is placed in accordance with usage frequency, whereas in the second embodiment, the data is placed in accordance with importance.

The data placement unit 2230 initially places the data having an importance 2413 of “1” in the fast memory. If the importance 2413 of any two data objects is equal, the data placement unit 2230 adapts to ensure that the maximum possible amount of data is placed in the fast memory. The data placement unit 2230 then proceeds to place the data in descending order of importance 2413.

For example if 4 KB of fast memory are available as shown in FIG. 8B, “data object M” which has a priority of “1” is placed in the fast memory, and “data object N”, which also has a priority of “1”, and “data object O”, which has an importance of “0.8”, are placed in the slow memory. With “pattern K”, since “data object P” is not placed, it will not be possible to execute any section of the application that uses “data object P”.

### MODIFICATIONS

The present invention has been described based on the above embodiments but is not limited to the above embodiments.

The execution device and/or program may be modified.

(1) In the first embodiment the usage frequency of each data object is determined using the cache hit rate, but other methods may be used. For example the usage frequency may be determined using a cache miss rate, or a number accesses to a data area. Alternatively, the usage frequency may be estimated using an algorithm or the like.

(2) In the embodiments the execution devices the memory is of two types, fast memory and slow memory. However, the execution device is not limited to this, and may include memory of a single type or three or more types.

Further, although the memory pattern prescribes only a size for each type of memory, the memory pattern may prescribe other aspects of the memories, including addresses, an alignment, or a method of allocation. The method of allocation includes, for example, details as to whether memory is entirely reserved for the application program or can be shared with another application program.

Further, the pattern may specify a type and amount of memory for each data object.

(3) In the first embodiment, when the data is placed in the data placement unit, the data placement unit checks the cache hit rate (see FIG. 5) for each data object. In the second embodiment, the data placement unit checks the importance of each data object (see FIG. 8). However, the placement order may alternatively be determined by checking both the cache hit rate and the importance, or by some other method.

(4) Although in the embodiments, the amount of memory provided for the application program is determined based on the amount of available memory, the amount of memory may be determined based on something else.

For instance, in the case of a battery powered apparatus such as a mobile device, the amount of memory supplied may alter according to the level of charge remaining in the battery. As the level of charge drops, the amount and type of memory provided to the application program may be reduced and altered respectively.

(5) The program for causing a CPU to realize the control processing (see FIG. 1) for the functions of the execution devices described in the embodiments can be recorded on a recording medium or otherwise distributed via a communications network, or the like. The recording medium may be an IC card, an optical disk, a flexible disk, ROM, a flash memory, or the like. An apparatus makes use Of the distributed program by storing the program in a CPU readable memory, and then having the CPU execute the program. The functions of the execution device of described in the above embodiments are then realized.

As described above, the present invention is applicable as a technology for manufacturing and using an integrated system that uses a processing system having a memory.

What is claimed is:

1. An execution device having at least one memory used by an application program during execution, comprising:
a storage unit operable to store a plurality of memory allocation patterns each relating to one or more memory areas of the at least one memory used for executing the application program;
a selection unit operable to select one of the memory allocation patterns stored in the storage unit;
an allocation unit operable to allocate the one or more memory areas in accordance with the memory allocation pattern selected by the selection unit; and
an execution unit operable to execute the application program using the one or more memory areas allocated by the allocation unit.

2. The execution device of claim 1, wherein
the application program includes a procedure corresponding to each memory allocation pattern stored in the storage unit, and
the execution unit is operable to execute at least the procedure corresponding to the selected memory allocation pattern using the one or more memory areas allocated by the allocation unit.

3. The execution device of claim 1, further comprising
an acquisition unit operable to acquire information relating to free areas of the one or more memories, wherein
the selection unit selects the one of the memory allocation patterns based on the acquired information.

4. The execution device of claim 1, wherein
the memories are of different types corresponding to different access speeds, and
each memory allocation pattern indicates a required amount of memory of each type.

5. The execution device of claim 4, further comprising:
an access frequency storage unit operable to store an access frequency estimated for each of one or more data objects to be used during execution of the application program; and
a placement unit operable, when the execution unit executes the application program, to place the one or more data objects in the memory areas allocated by the allocation unit, wherein
the placement unit places the one or more data objects according to the access frequencies stored in the access frequency storage unit.

6. The execution device of claim 1, further comprising:
a priority level storage unit operable to store a priority level for each of one or more data objects to be used when the application program is executed; and
a placement unit operable, when the execution unit executes the application program, to place the one or more data objects in the memory areas allocated by the allocation unit, wherein
the placement unit places, in order of decreasing priority, the one or more data objects using the priority levels stored in the priority level storage unit, and
when the application program is executed, the execution unit suppresses execution of portions of the application program that use data objects not placed by the placement unit.

7. An application program for causing an execution environment to execute functions for allocating and releasing memory, comprising steps of:
transmitting to the execution environment a plurality of differing memory allocation patterns relating to memory areas to be used when the application program is executed; and
acquiring from the execution environment one of the memory allocation patterns transmitted in the transmission step, wherein
prescribed processing to be performed by the execution environment is defined using the memory areas allocated in accordance with the acquired memory allocation pattern.

8. The application program of claim 7 using one or more data objects during execution, one or more sets of prescribed processing being in one-to-one correspondence with the one or more data objects, and the application program further comprising steps of:
judging whether one of the one or more data objects has been placed in the allocated memory area; and
controlling, in the execution environment, execution of the set of prescribed processing that corresponds to the data object judged to have been placed in the judging step.

9. An execution device having at least one memory used by an application program during execution, comprising:
a storage unit operable to store a plurality of memory allocation patterns each relating to one or more memory areas of the at least one memory used for executing the application program;
a selection unit operable to select one of the memory allocation patterns stored in the storage unit;
a notification unit operable to notify the application program of information relating to the memory allocation pattern selected by the selection unit.
